(19) United States
(12) Patent Application Publication
(10) Pub. No.: US 2005/0005137 A1
(43) Pub. Date: Jan. 6, 2005

(54) System and method for individualizing installation media

(75) Inventor: Mark Benedikt, Kirkland, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation

(21) Appl. No.: 10/463,559

(22) Filed: Jun. 16, 2003

(51) Int. Cl. H04L 9/32

(52) U.S. Cl. 713/189

(57) ABSTRACT

A system and method for installing content on a target computer using individualized installation media is provided. A computer-readable, strong installation key is delivered on the installation media. If the installation key is valid, a timed installation is created and an authentication request is made to an authentication server. If the authentication server determines that the timed installation is authorized, the server responds with an authentication response that is used by the target computer to convert the timed installation into a perpetual installation. The strong installation key may be delivered on various embodiments of installation media, including: a writable media and a read-only media, a hybrid disk, a double-sided DVD disk having a writable platter and a read-only platter, a read-only optical disk where the installation key is determined according to read errors in a reserved area, and an installation media including an RF identification tag.

### FIELD OF THE INVENTION

The present invention relates to installation media for delivering digital content and, in particular, to a system and method for individualizing digital content installation media.

### BACKGROUND OF THE INVENTION

In today's society, computer software, as well as other forms of digital content, has become extremely valuable. Unfortunately, due to the abilities of the computers upon which computer software, and other digital content, is installed, computer software may be easily pirated. According to recent studies, losses resulting from pirated software in the United States is estimated in the billions of dollars each year. In response, content providers have devised various anti-piracy measures to preclude such losses.

Anti-piracy measures can be grouped into two classes: indirect anti-piracy measures, and direct, or explicit, anti-piracy measures. Indirect anti-piracy measures do not prevent duplication or unauthorized use, instead they provide consequences after duplication or unauthorized use. Examples of indirect anti-piracy measures include enacting and enforcing laws, and marking authentic copies, using digital fingerprinting or watermarking, to identify counterfeits. Enacting and enforcing laws against those who are caught duplicating or utilizing illegal copies of computer software is an indirect anti-piracy measure because it does not specifically prevent duplication or illegal use, but imposes punishments to those who do so (that are caught). Digital fingerprinting, watermarking, etc. are also indirect because they are used to identify counterfeited products so that customs agents can destroy counterfeited goods, and honest citizens can refuse to purchase them. However, these are still indirect anti-piracy measures.

Alternatively, the goal of direct, or explicit, anti-piracy measures is to prevent the unauthorized duplication or use of digital content. In regard to unauthorized use of digital content generally, and computer software in particular, in order to prevent unauthorized use, the content is typically delivered in such a format as to require processing before it is usable. Then, by controlling this processing of the content, a content provider may ensure that the content's use is authorized. For example, the content may be delivered in an encrypted format, and processing the content involves decrypting the content using a decryption key. Encrypting and decrypting digital content is well known in the art.

As an alternative example, digital content may be delivered in a format that requires installation or customization to a particular computer, or other content rendering device and The installation process that installs or customizes the content is enabled through the use of a valid installation key that is provided with the content. Thus, by restricting the use of decryption or installation keys to authorized users, a content provider directly prevents unauthorized uses. As an added benefit realized by restricting the processing or installation of the content to authorized uses, unauthorized duplication of the media on which content is delivered becomes significantly less important. Unfortunately, current efforts aimed at limiting content installations to those that are authorized installations have been only marginally successful. However, the failings are not due to the idea behind restricting installations to authorized users, but rather to practical implementation factors.

Currently, most software applications, as well as other digital content, are delivered on mass-produced CD-ROMs. Accompanying the CD-ROM is an installation key that the user must manually enter during the installation process. The installation key is typically printed on a label and/or placed on printed material accompanying the CD-ROM. Often, an label is also placed on the case enclosing the CD-ROM. Incorrectly entering the installation key is interpreted as an invalid installation key and the installation process is aborted. If the installation key is genuine, and if the user correctly enters the installation key, the installation process continues with installing the computer software. Installation keys are typically encrypted tokens. The installation program decrypts the manually entered installation key. If the decryption process generates information containing a recognized pattern, the installation process is allowed to continue. Thus, it is essential that the installation key be properly entered.

Because the installation keys that are currently used must be manually entered by the user, they are typically short and, therefore, relatively weak in terms of their ability to be hacked or otherwise broken. However, shorter keys are used because usability studies have shown that the longer the installation key, the greater the user frustration becomes from entering it, and the more likely the user will err while inputting the key. In today's competitive market, it is imperative to minimize user frustration and maximize accuracy in entering the installation key. Thus, to ensure a positive experience on the user's behalf, content providers are forced to limit the length of installation keys, typically to under 30 characters. Unfortunately, the length of the installation key typically corresponds to the ease with which an installation key may be forged.

Forged installation keys are a primary reason that current anti-piracy efforts enjoy only limited success. Counterfeit key generators, capable of generating apparently authentic installation keys, are readily available on the Internet. Using these counterfeit key generators, current computer systems have the processing power to generate several counterfeit installation keys within a matter of a few hours.

By increasing the length of installation keys, and in particular the cryptographic strength of the installation keys, content providers could create installation keys sufficiently strong to prevent their forgery. For purposes of this discussion, a strong installation key is one that is not susceptible to encryption breaking processes using current or near future computer processing power. Taking into account the current processing power of computers today and the near future, a sufficiently strong installation key would include at least 512-bits of cryptographic data. A 512-bit cryptographic key roughly equates to 300 characters, about ten times the 30 character limit used today. However, requiring a user to manually enter a 300 character installation key is simply unreasonable.

What is lacking in the prior art is a system that provides unique, computer-readable, strong installation keys delivered with the installation media. As will be discussed below, the present invention addresses this, and other aspects currently lacking in the prior art.

### SUMMARY OF THE INVENTION

A system and method for installing content on a target computer using individualized installation media is provided. According to aspects of the present invention, a strong installation key is stored on the installation media. The installation process reads the strong installation key from the installation media and determines whether the key is a valid key. If the key is valid, a timed installation is created on the target computer. An authentication response is sent to an authentication server to determine whether the timed installation is an authorized installation. The authentication server determines whether the timed installation is an authorized installation, and if so, generates an authentication response indicating that the timed installation is an authorized installation. Upon receiving an authentication response indicating that the timed installation is an authorized installation, the timed installation is converted to a perpetual installation.

In accordance with other aspects of the present invention, a system and method for individualizing installation media is provided. A duplication device obtains an installation image for installation on a target computer and places the installation image on installation media. An individualization device obtains the installation media bearing the installation image from the duplication device. The individualization device then obtains a unique, strong installation key from a key generator, and writes the strong installation key onto the installation media.

In accordance with further aspects of the present invention, a computer-readable medium bearing computer-readable installation data is provided. The computer-readable medium includes a read-only area bearing an installation image that must be processed by an before it may be used for its intended purpose. The computer-readable medium also includes a writable area bearing a unique, strong installation key that enables processing the installation image.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of an exemplary computer system suitable for implementing aspects of the present invention;

FIG. 2 is a pictorial diagram of an exemplary networked computing environment suitable for implementing aspects of the present invention;

FIG. 3 is a pictorial diagram illustrating an exemplary computer software installation system for installing computer software as found in the prior art;

FIG. 4 is a pictorial diagram illustrating an exemplary computer software installation system for installing computer software using a strong installation key delivered on individualized installation media in a computer-readable format in accordance with the present invention;

FIGS. 5A-5G are pictorial diagrams illustrating exemplary embodiments of individualized installation media for delivering computer-readable, strong installation keys;

FIG. 6 is a pictorial diagram illustrating an exemplary individualize installation media system formed in accordance with the present invention;

FIG. 7 is a flow diagram illustrating an exemplary routine for generating individualized installation media for use in the exemplary computer software installation system of FIG. 4; and

FIGS. 8A and 8B illustrate a flow diagram of an exemplary routine for installing content on a computer.

### DETAILED DESCRIPTION

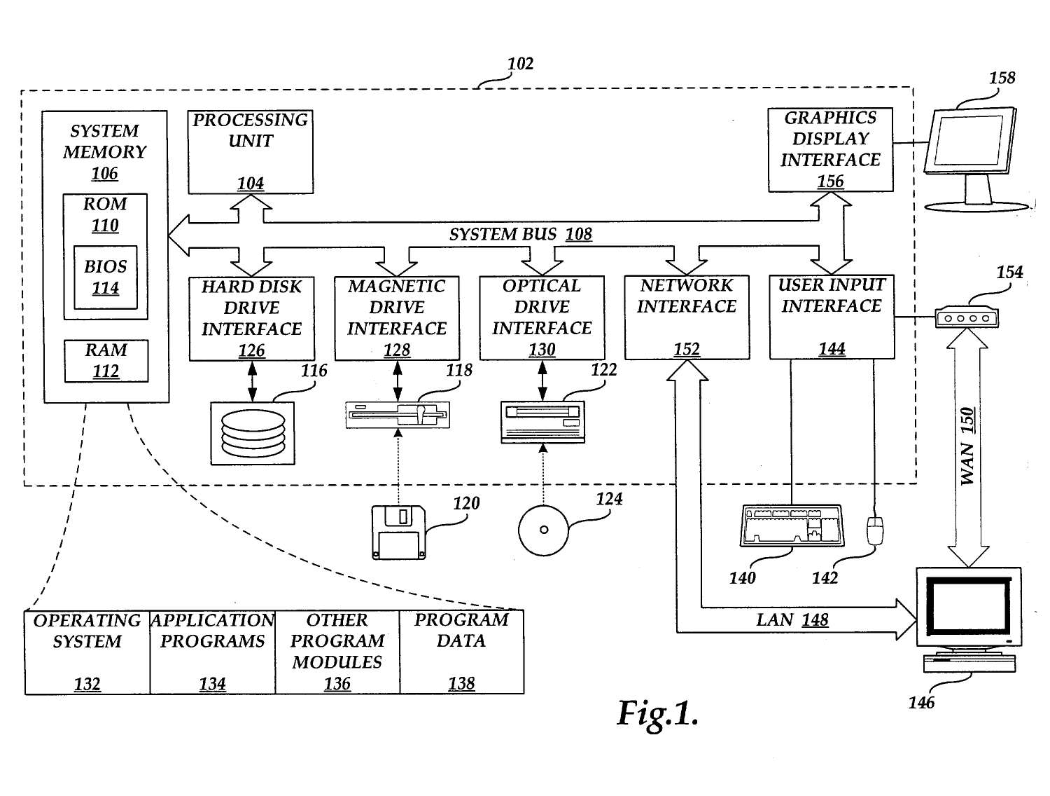

FIG. 1 and the following discussion are intended to provide a brief, general description of a computing system suitable for implementing various features of the invention. While the computing system will be described in the general context of a personal computer usable in a distributed computing environment, where complementary tasks are performed by remote computing devices linked together through a communication network, those skilled in the art will appreciate that the invention may be practiced with many other computer system configurations, including multiprocessor systems, minicomputers, mainframe computers, and the like. In addition to the more conventional computer systems described above, those skilled in the art will recognize that the invention may be practiced on other computing devices including laptop computers, tablet computers, personal digital assistants (PDAs), and other devices upon which computer software or other digital content is installed.

While aspects of the invention may be described in terms of application programs that run on an operating system in conjunction with a personal computer, those skilled in the art will recognize that those aspects also may be implemented in combination with other program modules. Generally, program modules include routines, programs, components, data structures, etc. that perform particular tasks or implement particular abstract data types.

With reference to FIG. 1, an exemplary system for implementing aspects of the invention includes a conventional personal computer 102, including a processing unit 104, a system memory 106, and a system bus 108 that couples the system memory to the processing unit 104. The system memory 106 includes read-only memory (ROM) 110 and random-access memory (RAM) 112. A basic input/output system 114 (BIOS), containing the basic routines that help to transfer information between elements within the personal computer 102, such as during startup, is stored in ROM 110. The personal computer 102 further includes a hard disk drive 116, a magnetic disk drive 118, e.g., to read from or write to a removable disk 120, and an optical disk drive 122, e.g., for reading a CD-ROM disk 124 or to read from or write to other optical media. The hard disk drive 116, magnetic disk drive 118, and optical disk drive 122 are connected to the system bus 108 by a hard disk drive interface 126, a magnetic disk drive interface 128, and an optical drive interface 130, respectively. The drives and their associated computer-readable media provide nonvolatile storage for the personal computer 102. Although the description of computer-readable media above refers to a hard disk, a removable magnetic disk, and a CD-ROM disk, it should be appreciated by those skilled in the art that other types of media that are readable by a computer, such as magnetic cassettes, flash memory cards, digital video disks, Bernoulli cartridges, ZIP disks, and the like may also be used in the exemplary operating environment.

A number of program modules may be stored in the drives and RAM 112, including an operating system 132, one or more application programs 134, other program modules 136, and program data 138. A user may enter commands and information into the personal computer 102 through input devices such as a keyboard 140 or a mouse 142. Other input devices (not shown) may include a microphone, touch pad, joystick, game pad, satellite dish, scanner, or the like. These and other input devices are often connected to the processing unit 104 through a user input interface 144 that is coupled to the system bus, but may be connected by other interfaces (not shown), such as a game port or a universal serial bus (USB). A display device 158 is also connected to the system bus 108 via a display subsystem that typically includes a graphics display interface 156 and a code module, sometimes referred to as a display driver, to interface with the graphics display interface. While illustrated as a stand-alone device, the display device 158 could be integrated into the housing of the personal computer 102. Furthermore, in other computing systems suitable for implementing the invention, such as a PDA, the display could be overlaid with a touch-screen. In addition to the elements illustrated in FIG. 1, personal computers also typically include other peripheral output devices (not shown), such as speakers or printers.

The personal computer 102 may operate in a networked environment using logical connections to one or more remote computers, such as a remote computer 146. The remote computer 146 may be a server, a router, a peer device, or other common network node, and typically includes many or all of the elements described relative to the personal computer 102. The logical connections depicted in FIG. 1 include a local area network (LAN) 148 and a wide area network (WAN) 150. Such networking environments are commonplace in offices, enterprise-wide computer networks, intranets, and the Internet.

When used in a LAN networking environment, the personal computer 102 is connected to the LAN 148 through a network interface 152. When used in a WAN networking environment, the personal computer 102 typically includes a modem 154 or other means for establishing communications over the WAN 150, such as the Internet. The modem 154, which may be internal or external, is connected to the system bus 108 via the user input interface 144. In a networked environment, program modules depicted relative to the personal computer 102, or portions thereof, may be stored in the remote memory storage device. It will be appreciated that the network connections shown are exemplary and other means of establishing a communication link between the computers may be used. In addition, the LAN 148 and WAN 150 may be used as a source of nonvolatile storage for the system.

It should be understood that while the following discussion of the present invention is described in terms of a personal computer 102 and computer software as the digital content, this is for illustration purposes and should not be construed as limiting upon the present invention. It is contemplated that other devices, upon which digital content, including computer software, may be installed, fall within the scope of the present invention. The content rendering devices include, but are not limited to, digital media players, personal video recorders/players, and the like.

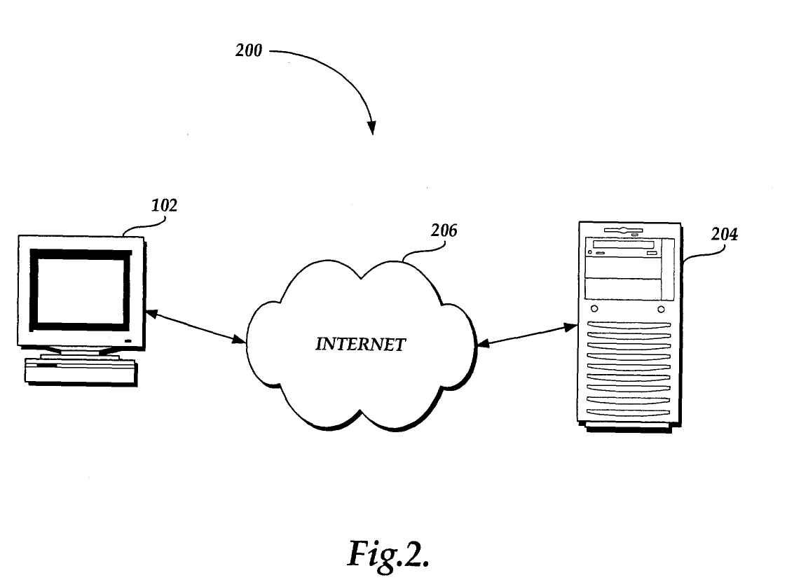

FIG. 2 is a block diagram of an exemplary networked computing environment 200 suitable for implementing aspects of the present invention. The exemplary networked computing environment 200 includes a target computer 102, described above in regard to FIG. 1, upon which a user may install computer software or other digital content from installation media. As shown in FIG. 2, the target computer 102 may be connected to a remote server 204 via a communication network, such as the Internet 206. Those skilled in the art will recognize that other communication networks may be used without departing from the scope of the present invention. As will be discussed in greater detail below, as part of the installation process, the target computer 102 may be required to communicate with a remote server 204 in order to limit the installation of content to authorized installations.

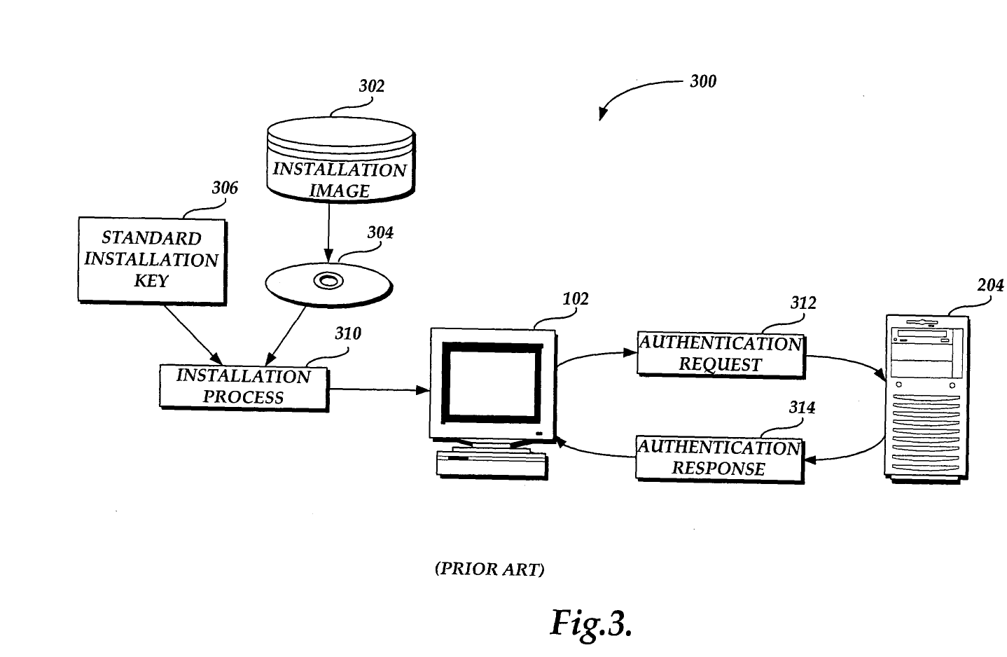

FIG. 3 is a pictorial diagram illustrating an exemplary computer software installation system 300 for installing computer software as found in the prior art. As part of delivering software to an end user, a software vendor will typically generate one or more installation files to be used for installing the content on a computer. These files are commonly referred to as an installation image 302. The installation image is not ready for execution, but must go thorough an installation process in order to be properly initialized or customized for use on a computer, such as the target computer 102. The installation image is then delivered to a production facility that mass-produces the installation media 304 containing the installation image 302. Typically, also included on the installation media 304 is an installation program (not shown) that is executed to install the computer software on the target computer 102.

Also accompanying the installation media 304 is a standard installation key 306. The installation key 306 is commonly printed on a label and placed on the printed material accompanying the installation media 304. Additionally, the installation key 306 is also commonly printed on a label and placed on the jewel case that encloses the installation media 304.

To install the computer software, a user inserts the installation media 304 into an appropriate drive, such as the optical drive 122 described above in regard to FIG. 1, and the installation process 310 begins. Those skilled in the art will readily recognize that the installation process 310, typically embodied in the installation program mentioned above, may be initiated automatically upon placing the installation media 304 in a suitable drive. Alternatively, the installation process 310 may be initiated by an explicit user action to do so, such as executing the installation program. One of the initial acts of the installation process 310 is to obtain the installation key 306 from the user. As previously discussed, in the prior art this usually entails the user entering the installation key. Assuming the installation key is authentic and the user correctly entered the installation key, the installation process 310 installs the computer software from the installation image onto the user's computer 102.

In order to ensure that a legitimate copy of the installation media and installation key are not borrowed to another, i.e., a legitimate copy of installation media and installation key are not used more than permitted by a license agreement, the decrypted installation key 306 includes a unique serial number that becomes permanently associated with the software installation during the installation process 310. This serial number is used by an authentication server 204, such as the remote server described in regard to FIG. 2, to ensure that only the permissible number of installations for an installation key 306 are allowed. Typically, only one authorized installation per installation key 306 is permitted.

The installation process 310, unable to determine whether the installation key 306 has been used for more than one installation, creates a timed installation of the computer software, meaning that the installed software will expire after a certain amount of time. If the software expires, it ceases to function for its intended purpose. Frequently, key features of a software installation are disabled when the installation expires, but leaving an option open to convert the expired installation to a fully functional, perpetual installation, i.e., one that will not expire. The time when the installation expires is set by the installation process 310, and is thus controlled by the content provider. As an example, the timed installation may be set to expire within 30 days of creating the timed installation unless it is converted to a perpetual installation.

In order to convert the timed installation to a perpetual installation the timed installation causes the target computer 102 to generate an authentication request 312, and send the authentication request to an authentication server 204. The authentication request typically includes certain installation information, including the serial number associated with the installation. The authentication request 312 may be sent over a communication network, such as the Internet 206 (FIG. 2), from the computer system 102 to the authentication server 204. Alternatively, the authentication request 312 may be transmitted by the user calling a customer service representative associated with the authentication server 204.

Upon receiving the authentication request 312, the authentication server 204 verifies whether the timed installation is legitimate according to an installation count associated with that installation's serial number. For example, on the first installation of the software using a unique serial number, the installation count would be zero, indicating that the serial number has not previously been used. Thus, if the computer software was legitimately installed on the computer 102, the authentication server 204 increases the installation count for the serial number and responds with an affirmative authentication response 314. The affirmative authentication response 314 includes information that enables the timed installation to be converted to a perpetual installation. Upon receiving the affirmative authentication response 314, the timed installation is converted to a perpetual installation. Alternatively, if the authentication server 204 determines that the serial number has already been used, or that no additional installations are permitted for the serial number, the authentication server responds with a negative authentication response 314. Data included in a negative authentication response may include instructions to disable the timed installation, or to simply let the timed installation expire.

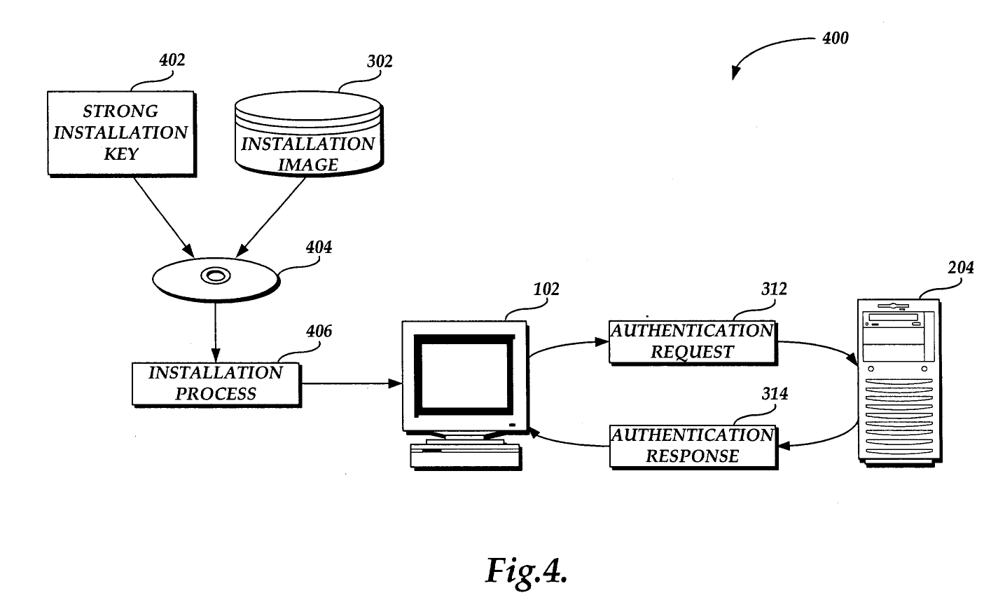

FIG. 4 is a pictorial diagram illustrating an exemplary computer software installation system 400 for installing computer software using a strong installation key delivered on individualized installation media in a computer-readable format in accordance with the present invention. As can be seen, FIGS. 3 and 4 share many similarities. However, in contrast to FIG. 3, the computer software installation system 400 of FIG. 4 utilizes a strong installation key 402. As previously discussed, a strong installation key 402 includes at least 512 bits of cryptographic data. However, even stronger installation keys may be utilized, such as installation keys having 1,024 or more cryptographic bits. As previously mentioned, a strong installation key is one that in not susceptible to decryption attacks. Thus, while the present discussion refers to a strong installation key as one that has a large number of cryptographic bits, it is for illustration purposes, and should not be construed as limiting on the present invention. Other cryptographic techniques may be devised that use relatively short keys that are not susceptible to decryption attacks and forgery. These also are contemplated as falling within the scope of the present invention. As a further alternative, a strong installation key may be represented as a digital certificate.

In further contrast to the computer software installation system 300 of FIG. 3, and in order to make use of strong installation keys, the installation image 302 and a strong installation key 402 are combined on the installation media 404. The strong installation key 402 is placed on the installation media 404 in a computer-readable manner such that the user is not required to enter the installation key. Because each strong installation key 402 is unique per each installation media, the installation media is referred to as individualized installation media.

When the installation process 406 begins, the strong installation key 402 is read from the individualized installation media 404 and used to generate a timed installation. As previously discussed, the timed installation generates an authentication request 312 to the authentication server 204, where the serial number associated with the timed installation is verified. As discussed, if the installation count associated with the serial number is a permissible number, an authentication response 314 is returned indicating that the timed installation is an authorized installation. A content provider may establish any number for an installation count, thereby permitting multiple installations per installation key. For example, a site license for software may include five installations. Accordingly, an appropriate installation count of up to five would be permissible. Data in the authentication response 314 is then used to convert the timed installation to a perpetual installation.

While the exemplary system of FIGS. 3 and 4 are described in regard to computer software installations, they are for illustration purposes and should not be construed as limiting upon the present invention. Those skilled in the art will recognize that any content deliverable in an installable format may take advantage of the present invention. Additionally, while the above-described system discusses placing an installation on the target computer 102, it is for illustration purposes and should not be construed as limiting upon the present invention. Those skilled in the art will recognize that one purpose of the installation process 406 is to enable the target computer 102 to use the content on the individualized installation media 404. Thus, any or all of the installation may remain on the media, and be logically considered as part of the installation on the target computer 102, so long as the target computer is able to use the content.

As described above, the present invention provides for delivering a strong installation key 402 on the installation media 404. Current mass-production techniques do not accommodate individualizing installation media with an installation key. In contrast, aspects of the present invention combine both mass-production and individualization.

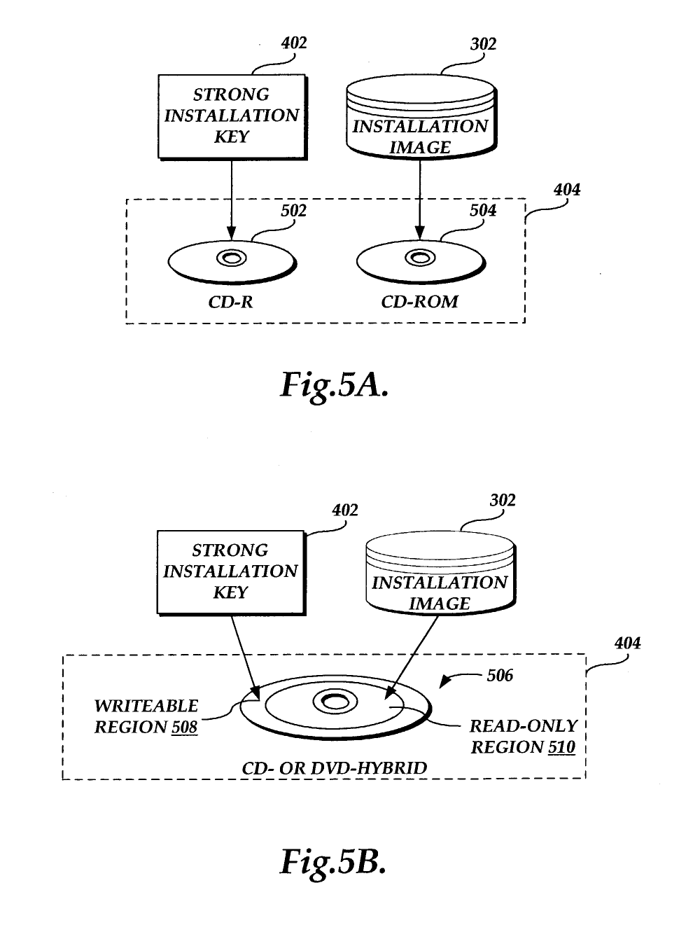

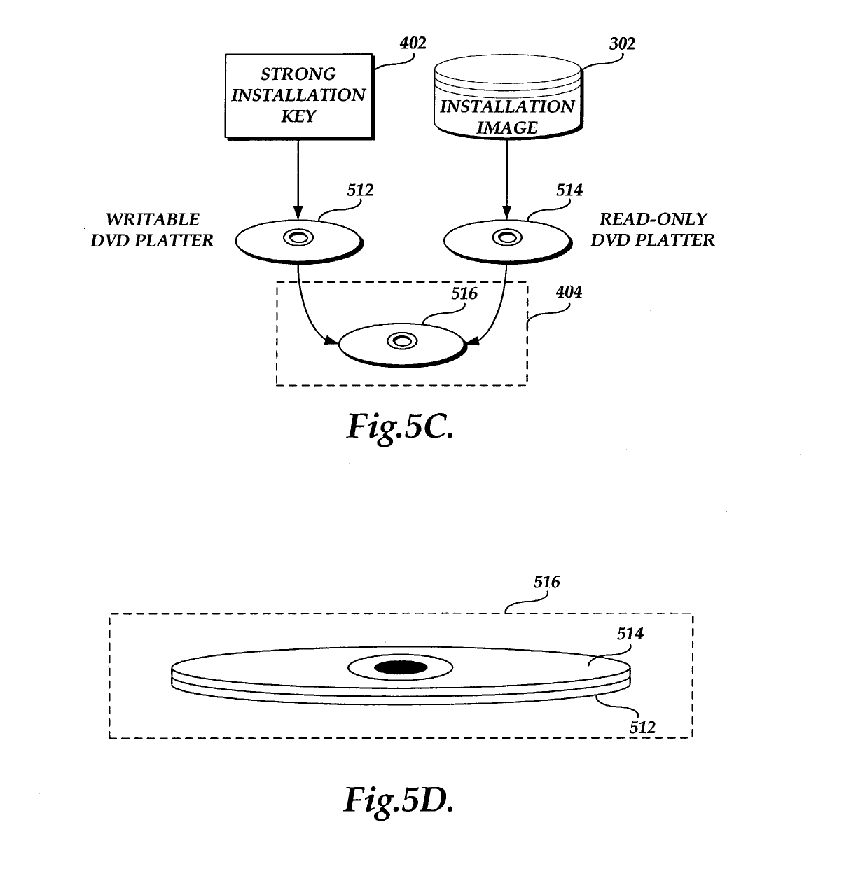

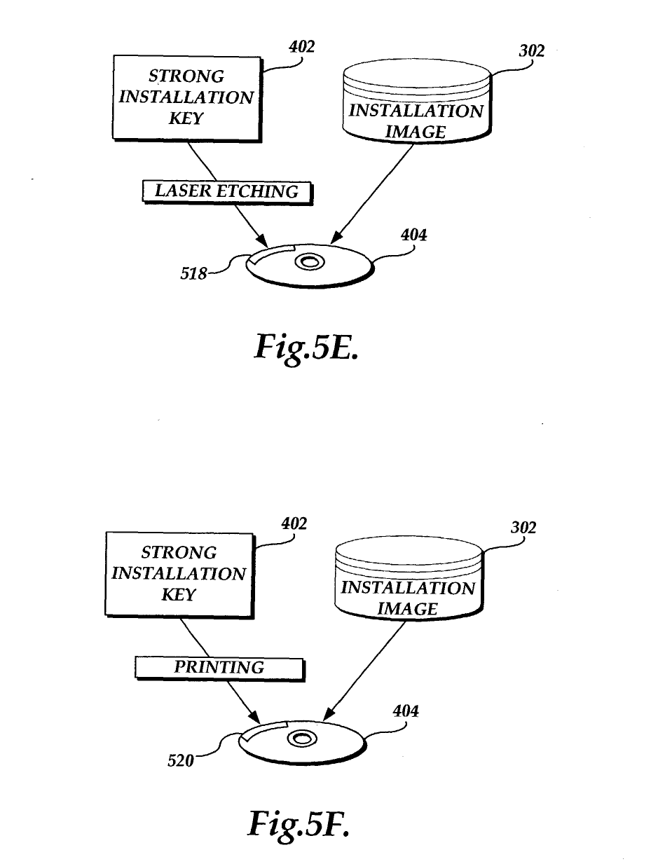

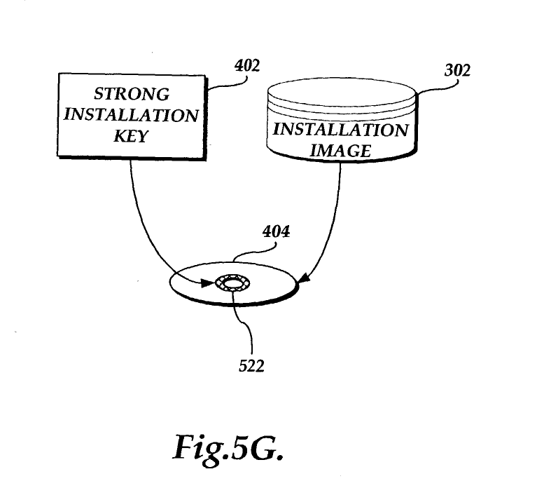

FIGS. 5A-5G are pictorial diagrams illustrating exemplary embodiments of individualized installation media 404, formed in accordance with the present invention, for delivering a computer-readable strong installation key 402. According to the embodiment illustrated in FIG. 5A, the installation image 302 is placed on read-only installation media 504, such as a CD-ROM disk, using typical mass-production techniques. The strong installation key 402 is placed on writable installation media 502. For example, the writable installation media may be a write-once CD-R disk. Other writable CD formats may also be used. Preferably, the writable installation media is write-once media to prevent erasure or modification of the strong installation key 402. Thus, according to this embodiment, the individualized installation media 404 includes at least two disks. In addition to the strong installation key 402 on the writable media 504, an installation program (not shown) may also be placed on the writable installation media 504 to facilitate the installation process 406.

FIG. 5B shows an exemplary embodiment of individualized installation media 404 for delivering a computer-readable strong installation key 402 and the installation image 302 on a hybrid disk 508 (either a CD-Hybrid or DVD-Hybrid disk.) The hybrid disk 508 includes a mass-produced read-only region 510, as well as a writable region 508. The installation image 302 is placed in the read-only region 510 during mass-production. Subsequent to mass-production, the strong installation key 402 is written to the writable region 508 of the hybrid disk 506.

FIGS. 5C and 5D illustrate an exemplary embodiment of individualized installation media 404 for delivering a computer-readable strong installation key 402 and installation image 302 on a single DVD disk 516. According to this embodiment, the software image 302 is placed on a read-only DVD platter 514 using well known mass-production techniques. The read-only DVD platter 514 is then combined with a writable DVD platter 512, such as a DVD-R or a DVD+R platter, as illustrated in FIG. 5D. Other writable DVD formats may also be used. Preferably, the writable DVD platter is a write-once platter to prevent modification or erasure of the strong installation key 402. The platters 512 and 514 are then joined together, such that the read-only DVD platter 514 is readable from one side of the resultant DVD disk 516, and the writable DVD platter 512 is readable from the opposite side of the DVD disk. In one embodiment of the present invention, the resultant DVD disk 516 conforms to the DVD-10 specification.

The strong installation key 402 is written on the writable DVD platter 510, either before or after the writable DVD platter 512 is combined with the read-only DVD platter 514. According to an alternative embodiment, because a DVD disk is able to store substantially more information than a CD-ROM disk, multiple strong installation keys may be written to the writable DVD platter 512. This may be especially useful in enterprise environments, which typically require one set of installation media 404 for all installations in the enterprise. Thus, by alternatively placing multiple strong installation keys on the DVD disk 516, each installation in the enterprise may be issued one of the multiple strong installation keys from one set of individualized installation media 404. It is estimated that using 512-bit encryption keys, over one million strong installation keys may be placed on a writable DVD platter 512.

FIG. 5E illustrates an exemplary embodiment of individualized installation media 404 for delivering a computer-readable strong installation key 402 using a technique known in the art as laser ablation. According to this embodiment, the individualized installation media 404 is optical media, such as a CD-ROM or DVD-ROM disk. The installation image 302 is placed on the installation media 404 using well known mass-production techniques. A reserved area 518 of the installation media 404 is reserved for the strong installation key 402. This reserved area 518 is readable by the optical disk reader, but is left blank of any data, such as the installation image 302 or the installation program. After the installation media 404 has been mass-produced, a subsequent process etches the strong installation key 402 into the reserved area 518 using the above-mentioned laser ablation technique. The laser ablation technique, using a laser, targets specific locations according to the strong installation key 402 on the individualized installation media 404 and vaporizes the data-bearing media there. This causes errors to be generated when reading those specific locations on the installation media 404. Thereafter, the strong installation key 402 may be determined according to the specific locations of read errors in the reserved area 518.

FIG. 5F illustrates an exemplary embodiment of individualized installation media 404 for delivering a computer-readable strong installation key 402 using modern printing technology capable of precisely placing small amounts of ink on a surface. According to this embodiment, individualized installation media 404 is optical media, such as a CD-ROM or a DVD-ROM disk. The installation image 302 is placed on the installation media 404 using mass-production techniques. As similarly described above in regard to FIG. 5E, an reserved area 520 on the installation media 404 is reserved for the strong installation key 402. The strong installation key 402 is placed in the reserved area 520 on the individualized installation media 404 by a printer, placing indelible ink at specific locations in the reserved area 520 according to the strong installation key 402. The ink obscures the media beneath it, causing read errors to occur when attempting to read those specific locations. Thus, as above in regard to FIG. 5E, the strong installation key 402 may be determined according to the specific locations of read errors in the reserved area 520.

FIG. 5G illustrates an exemplary embodiment of individualized installation media 404 for delivering a computer-readable strong installation key 402 using radio frequency (RF) identification tags. This embodiment is used on drives equipped to read both the mass-produced media, typically an optical disk, and an RF identification tag. The installation image 302 is placed on the individualized installation media 404 using mass-production techniques. An unused area of the individualized installation media 404, such as the inner ring of an optical disk, or the top surface of a CD-ROM disk or single sided DVD disk, receives an RF identification tag 522. For example, the inner ring of an optical disk may be embedded with an RF identification tag 522. Alternatively, the unused area, such as the inner ring or the entire top surface of a single sided optical disk, may have an RF identification tag 522 printed on it using commercially available printing techniques. Other techniques for placing an RF identification tag 522 on the unused area of the individualized installation media 404 may also be used. Additionally, the RF identification tag 522 may be encoded with the strong installation key 402 and placed on, or embedded within, the installation media 404 either before or after the RF identification tag 522 is added to the installation media.

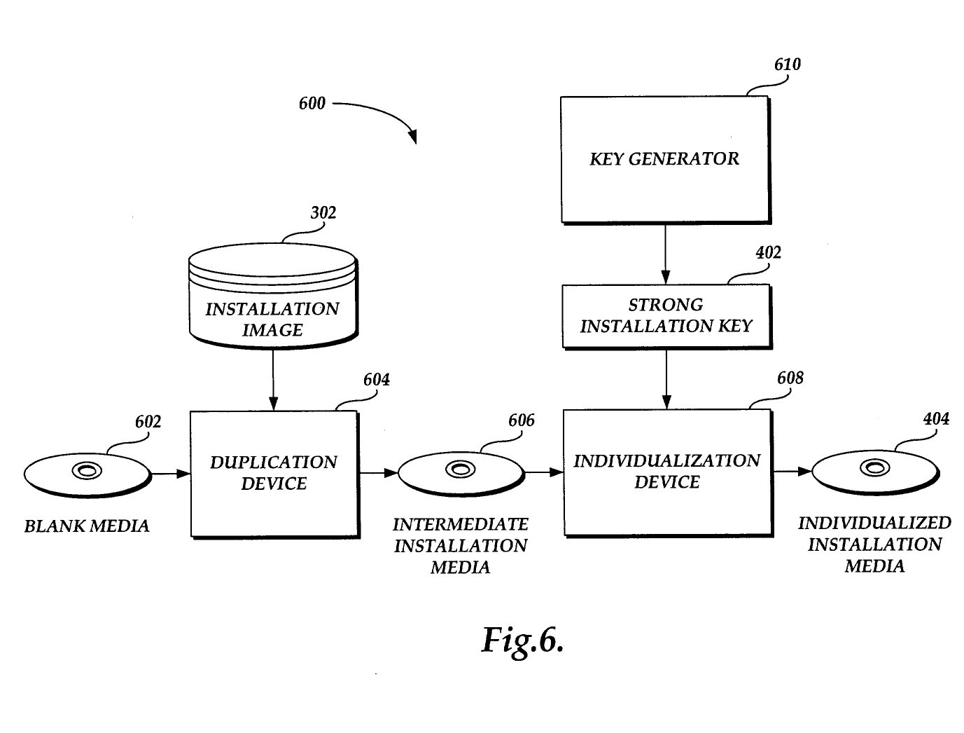

FIG. 6 is a pictorial diagram illustrating an exemplary individualized installation media system 600 formed in accordance with the present invention. As illustrated in FIG. 6, the installation image 302 and blank installation media 602 are obtained by a duplication device 604. The duplication device 604 is a logical component of the system 600 that may correspond to a specific physical device or to an entire duplication system that mass-produces installation media from a master image. These duplication systems are well known in the art. The duplication device 604 records the installation image 302 on blank installation media 602, thereby generating intermediate installation media 606.

An individualization device 608 obtains a strong installation key 402 from a key generator 610. The key generator 610 possesses the data and algorithms necessary to generate strong installation keys. While the algorithms to generate installation keys are sometimes discovered or made known, such as elliptical curve encryption, the data that is used by the algorithms is typically considered highly proprietary and kept secure and confidential to minimize piracy. Thus, for security purposes, the key generator 610 is typically not located at the production facility, but rather kept in a secure area maintained by the software provider. Delivering strong installation keys from a key generator 610 to the individualization device 608 is described in the co-pending application “System and Method for Securely Delivering Installation Keys to Installation Media”.

After obtaining the strong installation key, the individualization device 608 records the strong installation key on the intermediate installation media 606, thereby generating the individualized installation media 404. The individualized installation media 404 is now ready for distribution to a user for installation on a target computer 102. Individualization devices are well known in the art, and include CD and DVD writing devices, printers, laser ablation devices, and the like, corresponding to the particular embodiment of installation media selected. Exemplary embodiments are described above in regard to FIGS. 5A-5G.

It should be understood that while the individualization system 600 is described in terms of individualizing a single set of individualized installation media 404, it is for illustration purposes only. Those skilled in the art will recognize that a duplication device 604, such as a production system for stamping CD-ROMs or DVD-ROMs, handles large volumes of blank installation media 602 in a single run. Additionally, the duplication device 604 will typically produce intermediate installation media 608 far faster than the individualization device 608 may process them, due to the processes involved. Accordingly, in an actual embodiment, there may be multiple individualization devices 608 associated with a single duplication device 604.

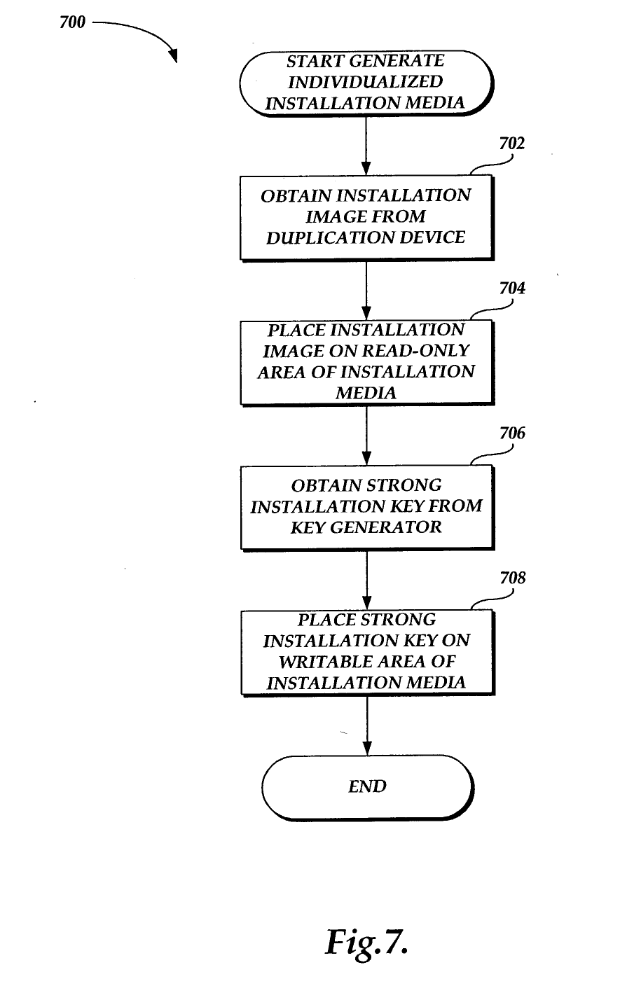

FIG. 7 is a flow diagram illustrating an exemplary routine 700 for generating individualized installation media 404 that is executed by the exemplary individualized installation media system 600 of FIG. 6. Beginning at block 702, the installation image 302 is obtained. Those skilled in the art will recognize that the installation image 302 is typically obtained from the software, or content provider. The installation image 302 is either obtained from the software provider on a set of master media, frequently referred to as a master, or is placed on a master by the duplication services, and is used to duplicate the installation image onto installation media. At block 704, the installation image 302 is placed on a read-only portion of the individualized installation media 404. Placing the installation image 302 on installation media using a master is well known in the art. At block 706, a strong installation key 402 for individualizing the installation media 404 is obtained from the key generator 610, as described above. At block 708, the strong installation key 402 is placed in a writable area of the individualized installation media 404. Thereafter, the routine 700 terminates.

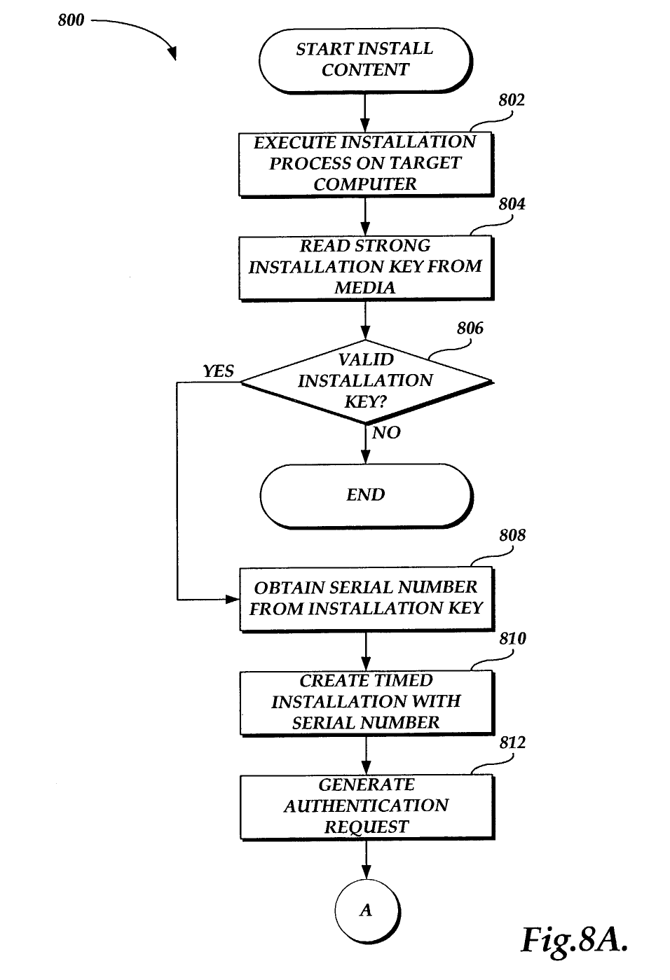

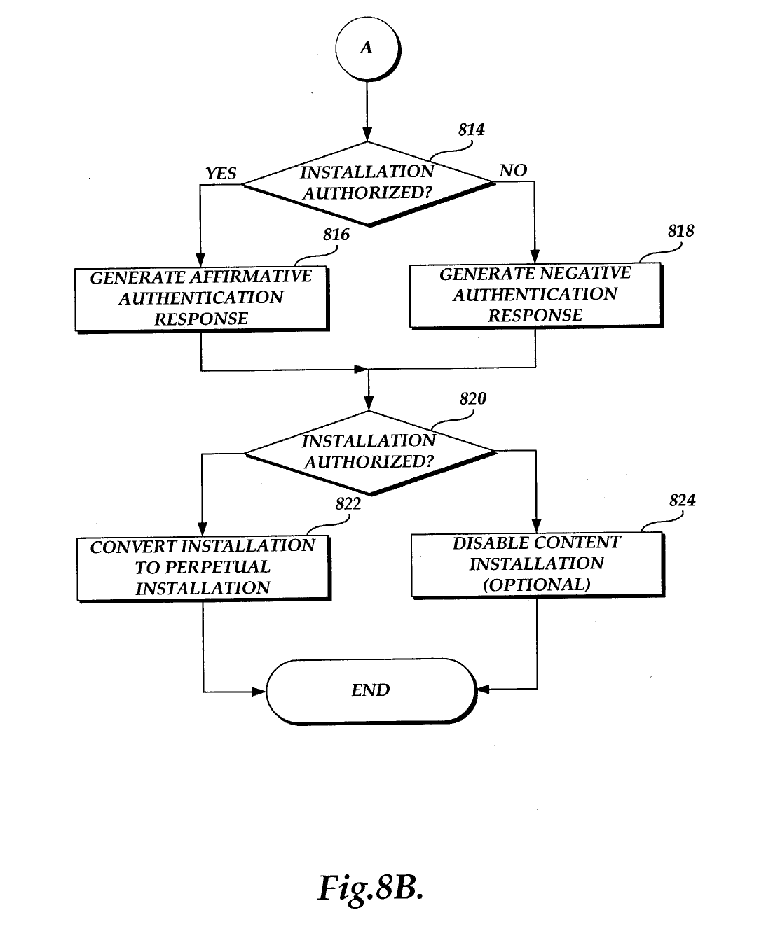

FIGS. 8A and 8B illustrate an exemplary routine 800 for installing content delivered on individualized installation media 404 on a target computer 102. Beginning at block 802 (FIG. 8A), an installation process 406 is executed on the target computer to install the content on the individualized installation media 404. At block 804, a strong installation key 402 is read from the individualized installation media 404. At decision block 806, the installation process 406 determines whether the strong installation key 402 is a valid installation key. As previously discussed, the strong installation key 402 is typically a token containing certain information and data, and is encrypted. Accordingly, determining whether the strong installation key 402 is a valid key comprises decrypting the key using a known process and detecting certain patterns with the decrypted information. If certain patterns are detected in the decrypted information, the installation key is considered valid. Those skilled in the art will recognize that other methods for determining the validity of the strong installation key 402 may also be used without departing from the scope of the invention.

If, a decision block 806, it is determined that the strong installation key 402 is not valid, the routine 800 terminates. Alternatively, if the strong installation key 402 is valid, at block 808, a serial number embedded within the strong installation key is extracted from the decrypted information. At block 810, a timed installation, individualized by the serial number, is created on the target computer 102. Timed installations have been described above in regard to FIGS. 3 and 4. At block 812, an authentication request 312 is generated. As discussed above, the authentication request 312 will include information, including the serial number, enabling an authentication server 204 to determine whether the timed installation is an authorized installation.

At decision block 814 (FIG. 8B), the authentication server 204 determines whether the timed installation is an authorized installation. As previously discussed, this determination may be made according to an installation count associated with the serial number included in the authentication request 312. Thus, when an installation request 312 is received relating to an authorized timed installation, the installation count is modified Thus, assuming that only one authorized installation per serial number is allowed, after the first timed installation associated with the serial number has been authorized, the modified installation count indicates that no additional installations should be authorized. Alternatively, multiple installations may be associated with a serial number to accommodate multiple installation licenses. In such cases, timed installations may be deemed authorized until a maximum count associated with the serial number is reached.

If the authentication server 204 determines that the timed installation is an authorized installation, at block 816, an authentication response 314, indicating that the timed installation is an authorized installation, is generated. Alternatively, if the timed installation is not an authorized installation, at block 818, the authentication server 204 generates an authentication response 314 indicating that the timed installation is not an authorized installation.

At decision block 820, upon receiving the validation response 314, a determination is made as to whether the authentication response indicates that the timed installation is an authorized installation. If the timed installation is an authorized installation, at block 822, the timed installation is converted to a perpetual installation. Alternatively, if the timed installation is not an authorized installation, at block 824, the timed installation is optionally disabled for use for its intended purpose. As previously discussed, upon received a negative authentication response 314, i.e., one that indicates that the timed installation is not an authorized installation, the timed installation may be permitted to operate until it expires. Additionally (not shown), the user may be prompted with a message indicating why the conversion from a timed installation to a perpetual installation failed, such as if the installation key is an invalid key. The user may also be prompted/invited to contact the content provider to resolve the issue. Thereafter, the routine 800 terminates.

While various embodiments of the invention has been illustrated and described, including the preferred embodiment, it will be appreciated that various changes can be made therein without departing from the spirit and scope of the invention.

1. A system for installing content on a target computer, the system comprising:
an individualized installation media storing a strong installation key in a computer-readable format and an installation image of the content to be installed; and
a target computer that validates the strong installation key and installs the content if the strong installation key is valid.

2. The system of claim 1 further comprising an authentication computer that authorizes the installation of the content on the target computer; and
wherein the target computer installs the content as a timed installation, and converts the timed installation to a perpetual installation if the authentication computer authorizes the installation of the content.

3. The system of claim 2, wherein the target computer generates an authentication request for the authentication computer to determine whether the timed installation is authorized.

4. The system of claim 3, wherein the strong installation key includes a unique identification number.

5. The system of claim 4, wherein the target computer installs the content using the unique identification number, such that the timed installation is identifiable according to the unique identification number.

6. The system of claim 4, wherein the authentication request includes the unique identification number, and wherein the authentication computer authorizes the installation of the content according to the unique identification number in the authentication request.

7. The system of claim 6, wherein the authentication computer determines whether the timed installation is an authorized installation according to an installation count associated with the unique identification number in the authentication request.

8. The system of claim 3, wherein the authentication computer generates an authentication response for the target computer indicating whether the installation of content is authorized or not.

9. The system of claim 8, wherein the authentication response includes information necessary to convert the timed installation to a perpetual installation if the installation of content is authorized.

10. The system of claim 2, wherein target computer disables the timed installation such that it is made unusable for its intended purpose if the installation of content is not authorized.

11. The system of claim 1, wherein the strong installation key is encrypted.

12. The system of claim 11, target computer that validates the strong installation key by decrypting the strong installation key and searching for particular data in the decrypted key, such that if the particular data is found, the strong installation key is valid.

13. The system of claim 1, wherein the strong installation key is stored on a writable area of the individualized installation media.

14. The system of claim 13, wherein writable area of the individualized installation media is a write-once area of the individualized installation media.

15. The system of claim 13, wherein the installation image is stored on a read-only area of the individualized installation media.

16. The system of claim 15, wherein the read-only area of the individualized installation media storing the installation image is mass produced.

17. The system of claim 15, wherein the individualized installation media comprises a read-only disk storing the installation image and a writable disk storing the strong installation key.

18. The system of claim 15, wherein the read-only area of the individualized installation media storing the installation image is a read-only region of a hybrid disk, and the writable area of the individualized installation media storing the strong installation key is a writable region of the hybrid disk.

19. The system of claim 15, wherein the read-only area of the individualized installation media storing the installation image is on a read-only DVD platter, and the writable area of the individualized installation media storing the strong installation key is on a writable DVD platter, and wherein the read-only DVD platter and the writable DVD platter are joined as a single double-sided DVD disk such that the read-only DVD platter may be read on one side of the DVD disk and the writable DVD platter may be read on the opposite side of the DVD disk.

20. The system of claim 15, wherein the individualized installation media is a read-only optical disk, and the writable area of the individualized installation media is a reserved area on the read-only optical disk, and wherein the strong installation key is written to the reserved area of the read-only optical disk by an operation that causes read errors to occur when attempting to read specific locations in the reserved area.

21. The system of claim 20, wherein the target computer reads the strong installation key from the writable area of the individualized installation media by reading the reserved area and determining the strong installation key according to the read errors that occur from reading specific locations in the reserved area.

22. The system of claim 20, wherein the operation that causes read errors to occur when attempting to read specific locations in the reserved area is a laser ablation process.

23. The system of claim 20, wherein the operation that causes read errors to occur when attempting to read specific locations in the reserved area is a printing process using indelible ink.

24. The system of claim 15, wherein the read-only area of the individualized installation media storing the installation image is a read-only optical disk, and wherein the writable area of the individualized installation media storing the strong installation key is a unused area on the read-only optical disk bearing an RF identification tag.

25. The system of claim 24, wherein the target computer reads the installation image and the strong installation key stored on the individualized installation media using a device that reads both the read-only optical disk and the RF identification tag.

26. A method for installing content from individualized installation media onto a target computer, the method comprising:
obtaining a strong installation key from the individualized installation media;
verifying that the strong installation key is valid; and if so installing the content on the target computer.

27. The method of claim 26, wherein installing the content on the target computer comprises creating a timed installation on the target computer.

28. The method of claim 27 further comprising:
determining whether the timed installation is authorized; and
converting the timed installation to a perpetual installation if the timed installation is authorized.

29. The method of claim 28, wherein the strong installation key includes a unique identification number.

30. The method of claim 29, wherein creating a timed installation on the target computer comprises creating a timed installation using the unique identification number, such that the timed installation is identifiable according to the unique identification number.

31. The method of claim 30, determining whether the timed installation is authorized comprises:
generating an authentication request to determine whether the timed installation is authorized; and
in response to the authentication request, receiving an authentication response indicating whether the timed installation is authorized or not.

32. The method of claim 31, wherein the authentication request includes the unique identification number, and wherein the timed installation is determined to be authorized or not according to the unique identification number.

33. The method of claim 32, wherein the timed installation is determined to be authorized or not according to the unique identification number and an installation count associated with the unique identification number.

34. The method of claim 33, wherein the authentication response includes information necessary to convert the timed installation to a perpetual installation if the authentication response indicates that the timed installation is authorized.

35. The method of claim 28 further comprising disabling the timed installation such that it is made unusable for its intended purpose if the authentication response indicates that the timed installation is not authorized.

36. The method of claim 25, wherein the strong installation key is encrypted.

37. The method of claim 36, wherein verifying that the strong installation key is valid comprises decrypting the strong installation key and searching for particular data in the decrypted key, such that if the particular data is found, the strong installation key is valid.

38. The method of claim 26, wherein the strong installation key is stored on a writable area of the individualized installation media.

39. The method of claim 38, wherein the writable area of the individualized installation media is a write-once area of the individualized installation media.

40. The method of claim 38, wherein the content is stored on a read-only area of the individualized installation media.

41. The method of claim 40, wherein the read-only area of the individualized installation media is mass produced.

42. The method of claim 40, wherein the individualized installation media comprises a read-only disk storing the content and a writable disk storing the strong installation key.

43. The method of claim 40, wherein the read-only area of the individualized installation media storing the installation image is a read-only region of a hybrid disk, and the writable area of the individualized installation media storing the strong installation key is a writable region of the hybrid disk.

44. The method of claim 40, wherein the read-only area of the individualized installation media storing the installation image is on a read-only DVD platter, and the writable area of the individualized installation media storing the strong installation key is on a writable DVD platter, and wherein the read-only DVD platter and the writable DVD platter are joined as a single double-sided DVD disk such that the read-only DVD platter may be read on one side of the DVD disk and the writable DVD platter may be read on the opposite side of the DVD disk.

45. The method of claim 40, wherein the individualized installation media is a read-only optical disk, and the writable area of the individualized installation media is a reserved area on the read-only optical disk upon which the strong installation key is written by an operation that causes read errors to occur when attempting to read specific locations in the reserved area.

46. The method of claim 45, wherein reading the strong installation key from the writable area of the individualized installation media comprises reading the reserved area and determining the strong installation key according to the read errors that occur from reading specific locations in the reserved area.

47. The method of claim 45, wherein the operation that causes read errors to occur when attempting to read specific locations in the reserved area is a laser ablation process.

48. The method of claim 45, wherein the operation that causes read errors to occur when attempting to read specific locations in the reserved area is a printing process using indelible ink.

49. The method of claim 40, wherein the read-only area of the individualized installation media storing the installation image is a read-only optical disk, and wherein the writable area of the individualized installation media storing the strong installation key an unused area on the read-only optical disk bearing an RF identification tag.

50. The method of claim 49, wherein the strong installation key and the installation image are read using a device capable of reading both the installation image from the read-only optical disk and the strong installation key from the RF identification tag.

51. A system for individualizing installation media bearing an installation image of content to be installed on a target computer, the system comprising:
a key generator that generates a strong installation key for use in installing the content on the target computer;
a duplication device that places the installation image on the installation media; and
an individualization device that writes the strong installation key generated by the key generator onto the installation media in a computer-readable format upon which the installation image has been placed by the duplication device.

52. The system of claim 51, wherein the duplication device places the installation image on a read-only area of the installation media.

53. The system of claim 52, wherein the individualization device writes the strong installation key to a writable area of the installation media.

54. The system of claim 53, wherein the individualized installation media comprises a read-only optical disk and a writable optical disk, and wherein the duplication device places the installation image on the read-only optical disk and the individualization device writes the strong installation key on the writable optical disk.

55. The system of claim 53, wherein the individualized installation media comprises a hybrid disk, and wherein the duplication device writes the installation image on a read-only area of the hybrid disk, and the individualization device writes the strong installation key to a writable area of the hybrid disk.

56. The system of claim 53, wherein the individualized installation media comprises a read-only DVD platter, and a writable DVD platter, wherein the duplication device writes the installation image on the read-only DVD platter and the individualization device writes the strong installation key on the writable DVD platter, and wherein the read-only DVD platter is joined with the writable DVD platter to form a double-sided DVD disk such that the read-only DVD platter may be read on one side of the DVD disk, and the writable DVD platter may be read on the opposite side of the DVD disk.

57. The system of claim 53, wherein the individualized installation media comprises a read-only optical disk and the writable area of the individualized installation media is a reserved area on the read-only optical disk, and wherein the individualized device writes the strong installation key in a computer-readable format to specific locations in the reserved area using a process that causes read errors to occur when attempting to read the specific locations in the reserved area.

58. The system of claim 57, wherein the individualization device writes the strong installation key in a computer-readable format to specific locations in the reserved area such that the strong installation key is determined according to the read errors that occur when reading the specific locations in the reserved area.

59. The system of claim 57, wherein the process that causes read errors to occur when attempting to read specific locations in the reserved area is a laser ablation process.

60. The system of claim 57, wherein the process that causes read errors to occur when attempting to read specific locations in the reserved area is a printing process.

61. The system of claim 53, wherein the individualized installation media comprises a read-only optical disk, and wherein the writable area of the individualized installation media is a non-optically readable area of the read-only optical disk.

62. The system of claim 61, wherein the writable area of the individualized installation media includes an RF identification tag, and wherein the individualization device writes the strong installation key to the RF identification tag.

63. A method for individualizing installation media that bears an installation image of content to be installed on a target computer, the method comprising:
generating a strong installation key for use in installing the content on the target computer;
placing the installation image on the installation media; and
writing the strong installation key in a computer-readable format onto the installation media.

64. The method of claim 63, wherein the installation image is placed on a read-only area of the installation media.

65. The method of claim 64, wherein the strong installation key is written to a writable area of the installation media.

66. The method of claim 65, wherein the writable area of the installation media is a write-once area of the installation media.

67. The method of claim 65, wherein the installation media comprises a read-only optical disk and a writable optical disk, and wherein the installation image is placed on the read-only optical disk and the strong installation key is written on the writable optical disk.

68. The method of claim 65, wherein the installation media comprises a hybrid disk, and wherein the installation image is placed on a read-only area of the hybrid disk and the strong installation key is written to a writable area of the hybrid disk.

69. The method of claim 65, wherein the installation media comprises a read-only DVD platter and a writable DVD platter, wherein the installation image is placed on the read-only DVD platter and the strong installation key is written on the writable DVD platter, and wherein the method further comprises joining the read-only DVD platter and the writable DVD platter to form a single double-sided DVD disk such that the read-only DVD platter may be read on one side of the DVD disk, and the writable DVD platter may be read on the opposite side of the DVD disk.

70. The method of claim 65, wherein the installation media comprises a read-only optical disk and the writable area of the installation media comprises a reserved area on the read-only optical disk, and wherein writing the strong installation key in a computer-readable format onto the installation media comprises writing the strong installation key to specific locations in the reserved area using a process that causes read errors to occur when reading the specific locations in the reserved area.

71. The method of claim 70, wherein the strong installation key is written to the specific locations in the reserved area such that the strong installation key may be determined according to the read errors that occur when reading the specific locations in the reserved area.

72. The method of claim 70, wherein the process that causes read errors to occur when reading specific locations in the reserved area is a laser ablation process.

73. The method of claim 70, wherein the process that causes read errors to occur when reading specific locations in the reserved area is a printing process.

74. The method of claim 65, wherein the installation media comprises a read-only optical disk and the writable area of the individualized installation media comprises a non-optically readable area of the read-only optical disk.

75. The method of claim 74, wherein the writable area of the individualized installation media includes an RF identification tag, and wherein writing the strong installation key in a computer-readable format onto the installation media comprises writing the strong installation key to the RF identification tag.

76. A computer-readable medium bearing computer-readable installation data, including:
a read-only area bearing an installation image, wherein the installation image must be processed by an installation process before it can be used for its intended purpose; and
a writable area bearing a computer-readable strong installation key, wherein the strong installation key enables the installation process to process the installation image such that the installation image can be used for its intended purpose.

77. The computer-readable medium of claim 76, wherein the read-only area bearing the installation image comprises a read-only optical disk, and wherein the writable area bearing the computer-readable strong installation key comprises a writable optical disk.

78. The computer-readable medium of claim 76, wherein the computer-readable medium is a hybrid disk, and wherein the read-only area bearing the installation image comprises the read-only area of the hybrid disk and the writable area bearing the computer-readable strong installation key comprises the writable area of the hybrid disk.

79. The computer-readable medium of claim 76, wherein the read-only area bearing the installation image comprises a read-only DVD platter and the writable area bearing the computer-readable strong installation key comprises a writable DVD platter; and
wherein the read-only DVD platter and the writable DVD platter are joined to form a single double-sided DVD disk such that the read-only DVD platter may be read from one side of the DVD disk and the writable DVD platter may be read from the opposite side of the DVD disk.

80. The computer-readable medium of claim 76, wherein the computer-readable medium comprises a read-only optical disk, and wherein the writable area bearing the computer-readable strong installation key comprises a reserved area on the read-only optical disk, the reserved area having been processed to cause read errors to occur when reading specific locations in the reserved area such that the computer-readable strong installation key may be determined according to the specific locations in the reserved area where read errors occur.

81. The computer-readable medium of claim 80, wherein the reserved area has been processed by a laser ablation process.

82. The computer-readable medium of claim 80, wherein the reserved area has been processed by a printing process.

83. The computer-readable medium of claim 76, wherein the computer-readable medium comprises a read-only optical disk, and wherein the writable area bearing the computer-readable strong installation key comprises unused area of the read-only optical disk.

84. The computer-readable medium of claim 83, wherein unused area of the read-only optical disk includes an RF identification tag, and wherein the computer-readable strong installation key is written to the RF identification tag.
